(19) United States
(12) Patent Application Publication
(10) Pub. No.: US 2024/0165822 A1
(43) Pub. Date: May 23, 2024

(54) CONTROL DEVICE FOR CALCULATING PARAMETERS FOR CONTROLLING POSITION AND POSTURE OF ROBOT

(71) Applicant: Fanuc Corporation, Minamitsuru-gun, Yamanashi (JP)

(72) Inventor: Yuki Ishii, Minamitsuru-gun, Yamanashi (JP)

(73) Assignee: Fanuc Corporation, Minamitsuru-gun, Yamanashi (JP)

(21) Appl. No.: 18/283,058

(22) PCT Filed: Mar. 23, 2022
(86) PCT No.: PCT/JP2022/013623

§ 371 Date: Sep. 20, 2023

(30) Foreign Application Priority Data
Mar. 30, 2021 (JP) 2021-057646

(51) Int. Cl. B25J 13/08; B25J 9/16

(52) U.S. Cl. CPC B25J 13/085; B25J 9/1656

(57) ABSTRACT

This control device includes a force sensor, and a parameter calculation unit for calculating a moving direction for moving a first workpiece, and the position of a workpiece end point when performing force control. An operator causes a robot to bring the workpiece end point of the first workpiece into contact with a corner of a second workpiece. The force sensor detects a force in a period in which the first workpiece is pressed along a pressing direction. The parameter calculation unit calculates the moving direction and the position of the workpiece end point, on the basis of forces detected by the force sensor for a plurality of pressing directions.

### CROSS REFERENCE TO RELATED APPLICATIONS

This is the U.S. National Phase application of PCT/JP2022/013623 filed Mar. 23, 2022, which claims priority to Japanese Patent Application No. 2021-057646, filed Mar. 30, 2021, the disclosures of each of these applications being incorporated herein by reference in their entireties for all purposes.

### FIELD OF THE INVENTION

The present invention relates to a controller for calculating parameters for controlling a position and an orientation of a robot.

### BACKGROUND OF THE INVENTION

A robot apparatus includes a robot and an operation tool attached to the robot, and can perform a predetermined operation while the robot changes position and orientation. A known robot apparatus is provided with a hand, as an operation tool, for gripping a workpiece and arranges the workpiece at a predetermined position. As an operation for precisely adjusting a position and an orientation of the workpiece, control of fitting one workpiece to another workpiece is known. Further, the control is known in which one workpiece is brought into contact with a predetermined position of another workpiece. For example, there is known a robot apparatus for performing an operation of inserting a workpiece into a hole or the like of a member fixed to a work stand (e.g., Japanese Unexamined Patent Publication No. 4-256526A).

When performing such operations, a controller of a robot corrects a position and an orientation of the robot while moving one workpiece toward another workpiece. In a known technique, force control such as compliance control is carried out by attaching a force sensor to a robot. In the force control, a position and an orientation of the robot can be corrected so as to make force in a predetermined direction detected by the force sensor fall within a determination range (Japanese Unexamined Patent Publication No. 2008-307634A and Japanese Unexamined Patent Publication No. 2017-127932A, for example).

### PATENT LITERATURE

[PTL 1] Japanese Unexamined Patent Publication No. 4-256526A
[PTL 2] Japanese Unexamined Patent Publication No. 2008-307634A
[PTL 3] Japanese Unexamined Patent Publication No. 2017-127932A

### SUMMARY OF THE INVENTION

In force control, a position and an orientation of a workpiece gripped by a robot can be adjusted based on output from a force sensor attached to the robot. When this control is performed, it is necessary to set a control point for the robot moving the workpiece. The control point for the force control can be set at a tip point of the workpiece or a tip point of an operation tool. Further, it is necessary to set a movement direction (vector) serving as a direction to be moved for fitting or pressing the workpiece.

Such parameters including the control point and the movement direction can be specified in at least one coordinate system of a tool coordinate system with the origin in the operation tool and a user coordinate system set by an operator. Commonly, the origin of the coordinate system can be set as the control point, and the direction of one coordinate axis of the coordinate system can be set as the movement direction. Then, the robot can be controlled based on the position of the origin of the coordinate system and the movement direction.

The tool coordinate system and the user coordinate system can be set by driving an actual robot. However, there is a problem that it is difficult for an operator who is not familiar with the operation of the robot to set the coordinate system. For example, when setting the user coordinate system for a workpiece fixed to a work stand, the operator determines three positions in a space by using the reference coordinate system set on the robot, and sets vectors parallel to the X-axis and the Y-axis. Further, the operator sets the user coordinate system including the X-axis, the Y-axis, and the Z-axis by specifying the position of the origin.

Thus, many procedures are involved in setting the coordinate system, and there is a problem in that it is difficult for an operator who is not familiar with the operation of the robot to set the coordinate system. In particular, when a direction in a three-dimensional space is specified by directions of coordinate axes, there is a problem that it is difficult to operate the robot.

One aspect of the present disclosure is a controller configured to calculate a parameter for performing a force control when a robot moves a first workpiece toward a second workpiece. The controller includes a force detector configured to detect force applied to one of the first workpiece and the contact member when the robot brings the first workpiece into contact with the contact member including a corner portion. The controller includes a parameter calculating unit configured to calculate a movement direction in which the first workpiece moves with respect to the second workpiece when the force control is performed and a position of a workpiece tip point serving as a control point in the force control. The force detector detects the force during a period in which the robot brings the workpiece tip point of the first workpiece into contact with the corner portion of the contact member and presses the first workpiece along a predetermined pressing direction. The parameter calculating unit acquires the force that is detected by the force detector and corresponds to each of a plurality of pressing directions when the first workpiece is pressed to the contact member in the plurality of pressing directions, and calculates the movement direction of the first workpiece and the position of the workpiece tip point of the first workpiece based on the force corresponding to the plurality of pressing directions.

Another aspect of the present disclosure is a controller configured to calculate a parameter for performing force control when a robot moves a second workpiece toward a first workpiece. The controller includes a force detector configured to detect force applied to one of the first workpiece and a contact member when the robot brings the contact member including a corner portion into contact with the first workpiece. The controller includes a parameter calculating unit configured to calculate a movement direction in which the second workpiece moves with respect to the first workpiece when the force control is performed and a position of a workpiece tip point serving as a control point in the force control. The force detector detects force during a period in which the robot brings the corner portion of the contact member into contact with the workpiece tip point of the first workpiece and presses the contact member along a predetermined pressing direction. The parameter calculating unit acquires the force that is detected by the force detector and corresponds to each of a plurality of pressing directions when the contact member is pressed to the first workpiece in the plurality of pressing directions, and calculates the movement direction of the second workpiece and the position of the workpiece tip point of the first workpiece based on the force corresponding to the plurality of pressing directions.

According to an aspect of the present disclosure, it is possible to provide a controller that calculates a parameter for performing force control for a robot by easy operation of the robot.

### BRIEF DESCRIPTION OF DRAWINGS

FIG. 1 is a schematic view of a first robot apparatus in an embodiment.

FIG. 2 is a block diagram of the first robot apparatus in the embodiment.

FIG. 3 is an enlarged perspective view when a first workpiece is fitted to a second workpiece.

FIG. 4 is a schematic view of the first robot apparatus when an end surface of the first workpiece is brought into contact with a corner portion of the second workpiece.

FIG. 5 is an enlarged perspective view when the first workpiece is brought into contact with the corner portion of the second workpiece.

FIG. 6 is a first schematic view illustrating a method of calculating a position and a movement direction of a workpiece tip point.

FIG. 7 is a second schematic view illustrating a method of calculating the position and the movement direction of the workpiece tip point.

FIG. 8 is a schematic view of the first robot apparatus illustrating the workpiece tip point and the movement direction generated in a parameter setting procedure.

FIG. 9 is an image of a robot and a workpiece displayed on a display part of a teach pendant.

FIG. 10 is a schematic view of a second robot apparatus according to the embodiment.

FIG. 11 is a schematic view of the second robot apparatus when a corner portion of the second workpiece is brought into contact with an end surface of the first workpiece.

FIG. 12 is an enlarged perspective view when the corner portion of the second workpiece is brought into contact with the end surface of the first workpiece.

FIG. 13 is a schematic view of the second robot apparatus for illustrating the workpiece tip point and the movement direction generated in the parameter setting procedure.

FIG. 14 is a schematic view of a third robot apparatus according to the embodiment.

FIG. 15 is a schematic view of the third robot apparatus when the end surface of the first workpiece is brought into contact with the corner portion of the second workpiece.

FIG. 16 is a schematic view of the third robot apparatus for illustrating the workpiece tip point and the movement direction generated in the parameter setting procedure.

FIG. 17 is a schematic view of a fourth robot apparatus according to the embodiment.

FIG. 18 is a schematic view of the fourth robot apparatus when the end surface of the first workpiece is brought into contact with the corner portion of the second workpiece.

FIG. 19 is a schematic view of the fourth robot apparatus for illustrating the workpiece tip point and the movement direction generated in the parameter setting procedure.

### DETAILED DESCRIPTION OF EMBODIMENTS OF THE INVENTION

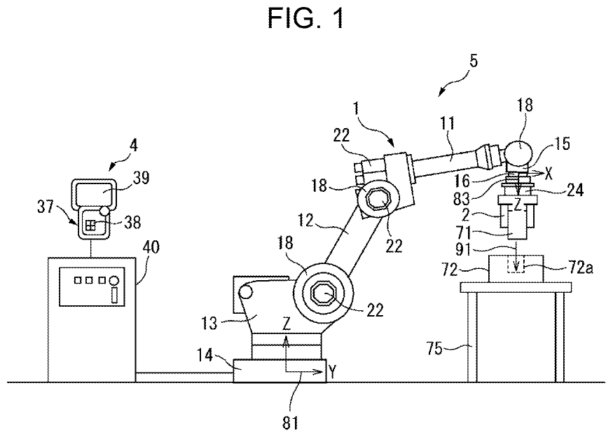

A controller in an embodiment will be described with reference to FIGS. 1 to 19. The controller according to the present embodiment calculates a parameter for performing force control when a robot moves one workpiece toward another workpiece. FIG. 1 is a schematic view of a first robot apparatus according to the present embodiment. A first robot apparatus 5 includes a hand 2 serving as an operation tool and a robot 1 configured to move the hand 2.

The robot 1 in the present embodiment is an articulated robot including a plurality of joints 18. The robot 1 includes a plurality of movable constituent members. The constituent members of the robot 1 are formed so as to rotate about respective drive axes. The robot 1 includes a base part 14, and a turning base 13 rotating with respect to the base part 14. The robot 1 includes an upper arm 11 and a lower arm 12. The lower arm 12 is rotatably supported by the turning base 13. The upper arm 11 is rotatably supported by the lower arm 12. The robot 1 includes a wrist part 15 rotatably supported by the upper arm 11. The hand 2 is fixed to a flange 16 of the wrist part 15. Further, the upper arm 11 and the flange 16 rotate about other drive axes.

The robot of the present embodiment includes six drive axes, but the embodiment is not limited to this. A robot that changes its position and orientation by any mechanism can be used. Further, the operation tool of the present embodiment is a hand including two claw parts, but the embodiment is not limited to this. As the operation tool, any device that can grip a workpiece can be used.

A reference coordinate system 81 is set for the robot apparatus 5 of the present embodiment. In the example illustrated in FIG. 1, the origin of the reference coordinate system 81 is located on the base part 14 of the robot 1. The reference coordinate system 81 is also referred to as a world coordinate system. The reference coordinate system 81 is a coordinate system in which a position of the origin is fixed, and further directions of coordinate axes are fixed. Even when the position and orientation of the robot 1 change, the position and orientation of the reference coordinate system 81 do not change. The coordinate system according to the present embodiment includes the X-axis, the Y-axis, and the Z-axis orthogonal to each other as coordinate axes. The coordinate system has the W-axis around the X-axis, the P-axis around the Y-axis, and the R-axis around the Z-axis.

The robot apparatus 5 has a tool coordinate system with the origin set at any position of the operation tool. In the present embodiment, the origin of the tool coordinate system is set at a tool center point that is a midpoint between tips of the two claw parts of the hand 2. The tool coordinate system is a coordinate system whose position and orientation are changed with the operation tool.

For example, the position of the robot 1 corresponds to the position of the origin of the tool coordinate system. Further, the orientation of the robot 1 corresponds to the orientation of the tool coordinate system with respect to the reference coordinate system 81.

In the robot apparatus 5, a flange coordinate system 83 with its origin at the flange 16 of the wrist part 15 is set. The flange coordinate system 83 is a coordinate system that moves and rotates together with the flange 16. The flange coordinate system 83 is set so that the origin is located on the surface of the flange 16, and the Z-axis overlaps the rotation axis of the flange 16.

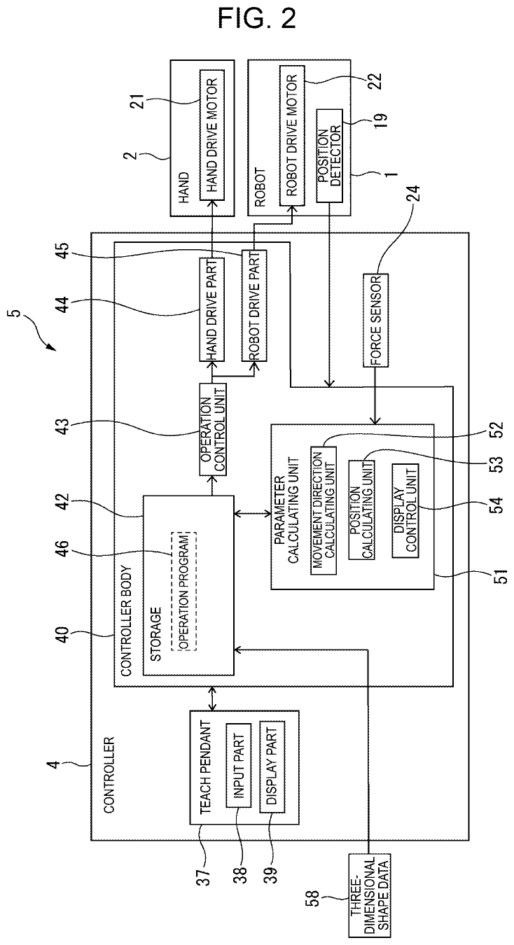

FIG. 2 is a block diagram illustrating the robot apparatus of the present embodiment. Referring to FIGS. 1 and 2, the robot 1 includes a robot drive device configured to change a position and an orientation of the robot 1. The robot drive device includes a robot drive motors 22 configured to drive constituent members such as an arm and a wrist part. In the present embodiment, a plurality of the robot drive motors 22 are arranged corresponding to the respective drive axes.

The robot apparatus 5 includes a hand drive device configured to drive the hand 2. The hand drive device includes a hand drive motor 21 configured to drive the claw part of the hand 2. The claw part of the hand 2 is opened or closed by being driven by the hand drive motor 21. It should be noted that the hand may be formed so as to be driven by air pressure or the like.

The robot apparatus 5 includes a controller 4 that controls the robot 1 and the hand 2. The controller 4 includes a controller body 40 configured to perform a control, and a teach pendant 37 for an operator to operate the controller body 40. The controller body 40 includes an arithmetic processing device (computer) including a central processing unit (CPU) serving as a processor. The arithmetic processing device includes a Random Access Memory (RAM) and a Read Only Memory (ROM), or the like, connected to the CPU via a bus.

The teach pendant 37 is connected to the controller body 40 via a communication device. The teach pendant 37 includes an input part 38 for inputting information regarding the robot 1 and the hand 2. The input part 38 is formed by input members, such as a keyboard and a dial. The teach pendant 37 includes a display part 39 configured to display information regarding the robot 1 and the hand 2. The display part 39 can be formed by any display panel such as a liquid crystal display panel or an organic EL (Electro Luminescence) display panel.

An operation program 46 generated in advance for driving the robot 1 and the hand 2 is input to the controller 4. Alternatively, the operator can set a teaching point of the robot 1 by operating the teach pendant 37 and driving the robot 1. The controller 4 can generate the operation program 46 for the robot 1 and the hand 2 based on the teaching point. The operation program 46 is stored in the storage 42.

The controller body 40 includes an operation control unit 43 configured to control the motion of the robot 1 and the hand 2. The operation control unit 43 sends motion commands to a robot drive part 45 for driving the robot 1 based on the operation program 46. The robot drive part 45 includes an electrical circuit for driving the robot drive motor 22. The robot drive part 45 supplies electricity to the robot drive motor 22 based on the motion command. The operation control unit 43 transmits a motion command to a hand drive part 44 for driving the hand 2 based on the operation program 46.

The hand drive part 44 includes an electric circuit for driving the hand drive motor 21. The hand drive part 44 supplies electricity to the hand drive motor 21 based on the motion commands.

The controller body 40 includes the storage 42 that stores information regarding the control of the robot 1 and the hand 2. The storage 42 can include a non-transitory storage medium that can store information. For example, the storage 42 can be formed by a storage medium, such as a volatile memory, a nonvolatile memory, a magnetic storage medium, or an optical storage medium.

The operation control unit 43 is equivalent to a processor that is driven in accordance with the operation program 46. The operation control unit 43 is formed so as to be able to read information stored in the storage part 42. The processor reads the operation program 46 and performs a control determined in the operation program 46, thereby functioning as the operation control unit 43. The robot 1 includes a state detector for detecting the position and the orientation of the robot 1.

The state detector according to the present embodiment includes a position detector 19 attached to the robot drive motor 22 on each drive axis and configured to detect a rotational position. The position detector 19 may be composed of an encoder for detecting a rotational angle of an output shaft of the robot drive motor 22. In the present embodiment, the position and the orientation of the robot 1 are detected based on output from a plurality of the position detectors 19.

The controller 4 of the first robot apparatus 5 includes a force sensor 24 as a force detector attached to the robot 1. The force sensor 24 according to the present embodiment is a six-axis sensor. In the first robot apparatus 5, the force sensor 24 is arranged between the flange 16 and the hand 2. The force sensor 24 detects force and a moment acting on a workpiece 71. As the force sensor 24, any force sensor such as a sensor including a strain sensor or a capacitance-type sensor can be used.

The force detected by the force sensor 24 in the present embodiment includes force in directions of three axes orthogonal to each other in a sensor coordinate system and force around the three axes. More specifically, the force sensor 24 detects force in directions of three orthogonal axes (X-axis, Y-axis, and Z-axis) and moments (Mx, My, and Mz) as force in directions of axes (W-axis, P-axis, and R-axis) around the three axes.

The first robot apparatus 5 of the present embodiment performs a control of fitting the first workpiece 71 to a second workpiece 72. The robot apparatus 5 moves the first workpiece 71 toward the second workpiece 72 using the robot 1. Then, as indicated by an arrow 91, the first workpiece 71 is inserted into a recess 72a of the second workpiece 72.

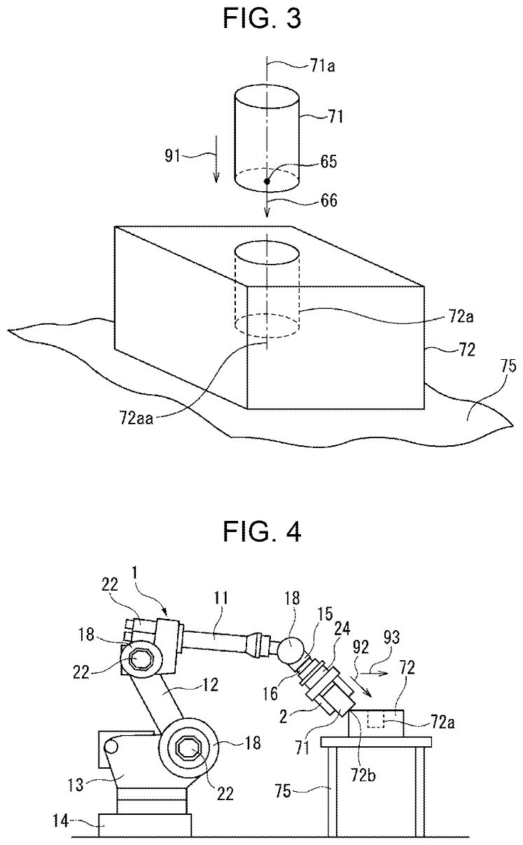

FIG. 3 is an enlarged perspective view of the first workpiece and the second workpiece in the present embodiment. The first workpiece 71 of the present embodiment has a cylindrical shape. An end surface of the first workpiece 71 has a circular shape. The second workpiece 72 has a rectangular parallelepiped shape. The second workpiece 72 is fixed to a work stand 75. The second workpiece 72 includes a surface on which the recess 72a is formed. The recess 72a is formed in a cylindrical shape. The recess 72a has a shape corresponding to the shape of the first workpiece 71 so that the first workpiece 71 fits therein.

As indicated by the arrow 91, the controller 4 performs a control of fitting the cylindrical workpiece 71 into the recess 72a of the workpiece 72. When a center axis 71a of the workpiece 71 and a center axis 72aa of the recess 72a are aligned, the workpiece 71 is smoothly inserted into the recess 72a of the workpiece 72. However, the center axis 72aa may shift in position or orientation relative to the center axis 71a.

Referring to FIGS. 2 and 3, the controller 4 performs a force control based on the output of the force sensor 24 when the workpiece 71 is fitted into the recess 72a. In the present embodiment, control of adjusting the position and orientation of the robot based on the force detected by the force detector is referred to as the force control. The force control utilizes force generated when the workpieces come into contact with each other. Based on the force detected by the force sensor 24, the controller 4 can perform a control of changing a speed of the workpiece in a direction orthogonal to the movement direction and a control for changing the orientation of the workpiece. The controller 4 can perform, for example, a compliance control, an impedance control, or the like based on the force detected by the force sensor 24.

When performing the force control described above, a control point serving as a reference for the force control and a movement direction (vector) for moving the workpiece by the robot are needed. The control point can be arranged at any position of either a workpiece moved by the robot or another workpiece being in contact with this workpiece. In the first robot apparatus 5, a workpiece tip point 65 serving as the control point is set on an end surface of the first workpiece 71. In the present embodiment, the workpiece tip point 65 is located at the center of a circle having a planar shape on the end surface of the first workpiece 71. When the workpiece 71 is fitted into the recess 72a, the direction indicated by an arrow 66 is set as the movement direction of the workpiece 71 supported by the robot 1.

Referring to FIG. 3, ideally, the force applied to the control point is only the force in the direction opposite to the movement direction, and when the moment around the control point is zero, the workpiece 71 is smoothly inserted into the recess 72a. In the force control, for example, the position and the orientation of the robot can be controlled so that the force applied to the control point in a direction other than the direction parallel to the movement direction and the moment around the control point are less than a predetermined determination value. By performing the force control, it is possible to perform fitting work while correcting the position and the orientation of the first workpiece 71 with respect to the recess 72a.

The controller 4 includes a parameter calculating unit 51 that calculates a parameter for performing the force control. The parameter calculating unit 51 includes a movement direction calculating unit 52 that calculates a movement direction in which the first workpiece 71 is moved with respect to the second workpiece 72 when the force control is performed. The parameter calculating unit 51 includes a position calculating unit 53 that calculates the position of the workpiece tip point located on the end surface of the first workpiece 71. The parameter calculating unit 51 includes a display control unit 54 that controls an image displayed on the display part 39 of the teach pendant 37.

The operation program 46 includes a calculation program for calculating a parameter for performing the force control. The parameter calculating unit 51 corresponds to a processor that is driven in accordance with the calculation program. The processor performs a control determined in the calculation program and thereby functions as the parameter calculating unit 51. Each of the movement direction calculating unit 52, the position calculating unit 53, and the display control unit 54 corresponds to the processor that is driven in accordance with the calculation program. The processor performs a control determined in the calculation program and thereby functions as the respective units.

In the present embodiment, control of calculating the parameter for performing the force control is referred to as a parameter setting procedure. In the parameter setting procedure of the first robot apparatus 5, the position of the workpiece tip point 65 as the control point is calculated. The movement direction (vector) indicated by the arrow 66 for moving the first workpiece 71 with respect to the second workpiece 72 is calculated.

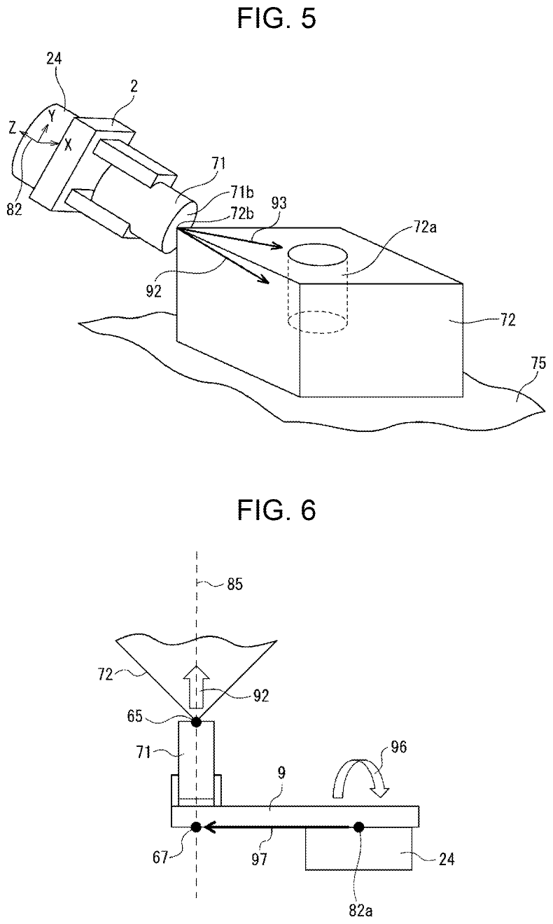

FIG. 4 is a schematic view of the first robot apparatus for explaining an operation of the robot in the parameter setting procedure. FIG. 5 is an enlarged perspective view of a portion where the first workpiece is in contact with the second workpiece. With reference to FIGS. 4 and 5, the operator can manually change the position and the orientation of the robot 1 by operating the teach pendant 37.

The operator changes the position and the orientation of the robot 1 so as to bring an end surface 71b of the workpiece 71 into contact with a corner portion 72b of the workpiece 72. In this example, the second workpiece 72 is used as a contact member with which the first workpiece 71 is brought into contact. The contact member is a member having a corner portion including a sharp tip that can be brought into contact with the first workpiece 71.

The operator changes the position and the orientation of the robot 1 and brings the workpiece tip point on the end surface 71b of the workpiece 71 for performing actual fitting work into contact with the corner portion 72b of the workpiece 72. The workpiece tip point 65 is the contact point between the workpiece 71 and the workpiece 72. In the present embodiment, control of pressing the first workpiece 71 onto the second workpiece 72 is performed multiple times. At this time, the direction in which the first workpiece 71 is pressed to the second workpiece 72 is changed. In the present embodiment, a direction in which one member is pressed to another member is referred to as a pressing direction. The pressing direction can be predetermined by the operator.

When the first workpiece 71 is pressed to the second workpiece 72 in a plurality of the pressing directions, the parameter calculating unit 51 acquires the force detected by the force sensor 24 corresponding to each pressing direction. The parameter calculating unit 51 calculates the movement direction of the first workpiece and the position of the workpiece tip point of the first workpiece based on the force corresponding to the plurality of pressing directions.

In the first control of pressing the first workpiece 71, the operator drives the robot 1 so as to press the first workpiece 71 in a predetermined pressing direction indicated by an arrow 92. In this example, the arrow 92 corresponds to a direction (movement direction) in which the first workpiece 71 is moved when the actual fitting work is performed. The operator drives the robot 1 so as to move the hand 2 in a direction substantially parallel to the center axis of the cylindrical workpiece 71. The force sensor 24 detects the force applied to the workpiece 71 during a period in which the robot 1 is driven so that the first workpiece 71 presses the second workpiece 72. A sensor coordinate system 82 for detecting the force applied to the sensor is set in the force sensor 24.

In the second control of pressing the first workpiece 71, the operator presses the first workpiece 71 in a predetermined pressing direction indicated by an arrow 93. The robot 1 is driven so as to press the first workpiece 71 to the second workpiece 72 in a direction different from the direction in which the first workpiece 71 is pressed in the first control. The force sensor 24 detects the force applied to the workpiece 71 during a period in which the robot 1 is driven so that the first workpiece 71 presses the second workpiece 72.

FIG. 6 is a first schematic view illustrating a method of calculating the pressing direction of the workpiece and the position of the contact point. In this example, the first workpiece 71 is gripped by a gripping member 9 corresponding to the hand. The force sensor 24 is attached to the gripping member 9. An origin 82a of the sensor coordinate system is set in the force sensor 24. FIG. 6 illustrates a state in which the first workpiece 71 is pressed in the pressing direction in the first control. The first workpiece 71 is pressed in the direction indicated by the arrow 92 toward the second workpiece 72 by driving the robot. The force sensor 24 detects force in the directions of the X-axis, the Y-axis, and the Z-axis, and moments in the directions of the W-axis, the P-axis, and the R-axis in the sensor coordinate system.

In the first control of pressing the first workpiece 71, the first workpiece is pressed in the direction indicated by the arrow 92. The movement direction calculating unit 52 detects the direction in which the first workpiece 71 is pressed to the second workpiece 72. The movement direction calculating unit 52 acquires components of force output by the force sensor 24 in the respective orthogonal axes (the X-axis, the Y-axis, and the Z-axis). The movement direction calculating unit 52 calculates the pressing direction of the workpiece 71 indicated by the arrow 92 from the components of the force of the respective orthogonal axes.

The force sensor 24 detects moments (Mx, My, and Mz) of the respective axes (the W-axis, the P-axis, and the R-axis) around the orthogonal axes, as indicated by an arrow 96. Based on the moments of the respective axes, the position calculating unit 53 calculates a position vector of a proximal point 67 closest to a line parallel to the pressing direction of the workpiece, from the origin 82a of the sensor coordinate system 82, as indicated by an arrow 97. The position calculating unit 53 calculates a line of action 85 that is parallel to the pressing direction of the workpiece 71 indicated by the arrow 92 and passes through the proximal point 67. The workpiece tip point 65 serving as the contact point is located on the line of action 85. Thus, the line of action 85 passing through the proximal point 67 can be calculated as a range including the workpiece tip point 65.

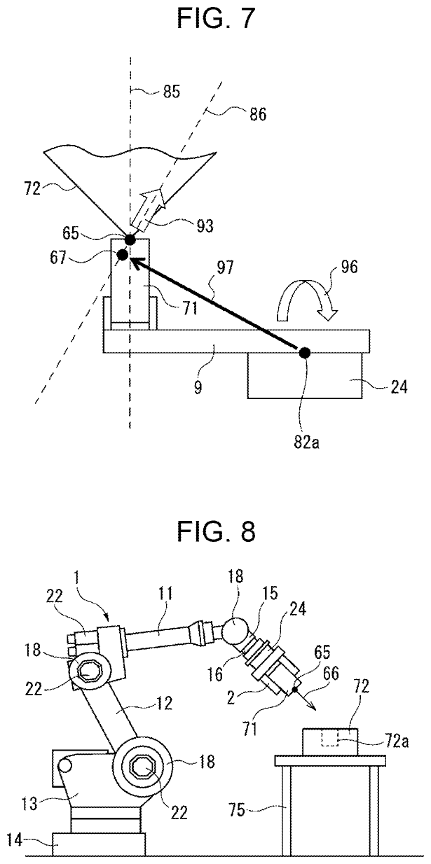

FIG. 7 is a second schematic view illustrating the method of calculating the pressing direction of the workpiece and the position of the contact point. In the second control of pressing the workpiece, the pressing direction of the first workpiece 71 is set to a direction different from that in the first control of pressing the workpiece. In other words, the first workpiece 71 is pressed in a different direction toward the second workpiece. In this case, the first workpiece 71 is pressed in the direction indicated by the arrow 93. The movement direction calculating unit 52 calculates the pressing direction of the workpiece 71 indicated by the arrow 93 from the components of the force of the respective orthogonal axes. The position calculating unit 53 calculates a line of action 86 that passes through the proximal point 67 and is parallel to the pressing direction of the workpiece 71.

The workpiece tip point 65 is located on the line of action 86.

Next, the position calculating unit 53 calculates an intersection point between the line of action 85 corresponding to the pressing direction in the first control and the line of action 86 corresponding to the pressing direction in the second control. The position calculating unit 53 sets the intersection point as the workpiece tip point 65. The position calculating unit 53 calculates the position of the intersection point as the position of the workpiece tip point 65. Thus, the position calculating unit 53 can calculate the workpiece tip point as the intersection point between a plurality of lines of action. The movement direction calculating unit 52 can set the detected one pressing direction among the directions detected in a plurality of the control for pressing the workpiece as the movement direction when the force control is implemented. In this example, the movement direction calculating unit 52 sets the direction indicated by the arrow 92 in the first pressing control as the movement direction. The operator can select the pressing direction to be set to the movement direction among a plurality of pressing directions calculated in the pressing control performed multiple times.

In the present embodiment, the control of pressing the workpiece in the two pressing directions is performed, but the embodiment is not limited to this. Control of pressing the workpiece in three or more pressing directions may be performed. In this case, it is preferable that the robot is driven so that one workpiece is pressed to another workpiece in different directions. The position calculating unit acquires force corresponding to each pressing direction and detected by a detector. The position calculating unit calculates a plurality of lines of action corresponding to the plurality of pressing directions. The position calculating unit can calculate the intersection point between a plurality of lines of action as the contact point. Increasing the number of workpiece pressing directions improves the accuracy of calculating the contact points.

When a plurality of lines of action are calculated, the plurality of lines of action may not intersect each other at one point due to measurement error or the like. When the workpiece is pressed in two pressing directions, a midpoint of a line segment connecting points of two lines of action closest to each other may be calculated as the contact point. Further, when the workpiece is pressed in three or more pressing directions, at least one line of action among the plurality of lines of action may not intersect another line of action. In this case, the position calculating unit can calculate the position of the workpiece tip point based on the distances from the plurality of lines of action. The position calculating unit can calculate, as the contact point, a point with short distances from the plurality of lines of action. For example, the position calculating unit can calculate, as the contact point, a point with the minimum sum or variance of the distances from the plurality of lines of action.

FIG. 8 is a schematic view of the robot apparatus illustrating the workpiece tip point set on the first workpiece and the movement direction of the workpiece. In the first robot apparatus 5, the movement direction indicated by the arrow 66 and the workpiece tip point 65 move together with the first workpiece 71. The movement direction and the position of the workpiece tip point can be calculated by using coordinate values of the sensor coordinate system 82. Specifically, the movement direction calculating unit 52 can calculate the movement direction indicated by the arrow 66 in the sensor coordinate system 82. The position calculating unit 53 can calculate the position of the workpiece tip point 65 in the sensor coordinate system 82.

The relative position and orientation of the sensor coordinate system 82 with respect to the flange coordinate system 83 set on the flange 16 of the robot 1 are determined in advance. The parameter calculating unit 51 is calibrated so that the coordinate values of the sensor coordinate system 82 can be converted into the coordinate values of the flange coordinate system 83. The parameter calculating unit 51 converts the movement direction and the position of the workpiece tip point expressed in the sensor coordinate system 82 into the movement direction and the position of the workpiece tip point expressed in the flange coordinate system 83.

The parameter calculating unit 51 can set the movement direction and the position of the workpiece tip point expressed in the flange coordinate system 83 in the operation program 46 as parameters (set values) of force control. Alternatively, the display control unit 54 can display, on the display part 39, the movement direction and the position of the workpiece tip point to be calculated. The operator can set the movement direction and the position of the workpiece tip point in the operation program 46, while viewing the display on the display part 39.

Next, the operator specifies the position and the orientation of the workpiece 71 with respect to the workpiece 72 at the time of starting the operation for fitting the workpiece 71. The operator operates the teach pendant 37 to change the position and the orientation of the robot 1, so as to dispose the workpiece 71 directly above the recess 72a as illustrated in FIGS. 1 and 3. The position and the orientation of the workpiece 71 are changed so that the center axis 72aa of the recess 72a and the center axis 71a of the workpiece 71 are substantially linearly arranged. The position and the orientation of the robot 1 at this time are the initial position and the initial orientation of the robot when starting the control of fitting the first workpiece 71 to the second workpiece 72.

The parameter calculating unit 51 sets the initial position and orientation of the robot in the operation program 46. Alternatively, the display control unit 54 may display the initial position and orientation of the robot on the display part 39, and then the operator may set them in the operation program 46.

Referring to FIGS. 1 and 3, in the actual fitting work, the operation control unit 43 controls the position and the orientation of the robot 1 based on the operation program 46 so that the workpiece 71 is placed at the initial position and the initial orientation. Next, the operation control unit 43 starts the force control. The operation control unit 43 moves the workpiece 71 in the movement direction indicated by the arrow 66. When the first workpiece 71 comes into contact with the second workpiece 72, the force is detected by the force sensor 24.

The operation control unit 43 can convert the force detected by the force sensor 24 into force acting on the workpiece tip point 65. Then, the position and orientation of the robot can be controlled so that the force acting on the workpiece tip point 65 falls within a predetermined determination range. In this manner, the force control can be performed based on the movement direction indicated by the arrow 66 and the position of the workpiece tip point 65.

In known techniques, a coordinate system needs to be set for determining the position of the workpiece tip point and the direction in which the workpiece is fitted. For example, when a workpiece is fitted into a recess of another workpiece fixed to a work stand, a user coordinate system needs to be set for the recess of the workpiece. On the other hand, in the parameter setting procedure according to the present embodiment, no coordinate system needs to be set for the workpiece, and the parameter for performing the force control can be easily set. In particular, in the present embodiment, no coordinate system needs to be set in a three-dimensional space. Thus, even an operator who is not familiar with the operation of the robot can easily set the parameter of the force control.

In the above-described embodiment, the second workpiece 72 is used as a contact member with which the first workpiece 71 is brought into contact, but the embodiment is not limited to this. As the contact member, any member including a corner portion having a vertex can be used. For example, a jig having a corner portion may be fixed to the work stand, and the end surface of the first workpiece may be brought into contact with the corner portion of the jig.

In the above-described embodiment, the robot is operated by using the teach pendant so as to bring the first workpiece into contact with the second workpiece, but the embodiment is not limited to this. The operator can perform any control for manually changing the position and the orientation of the robot. For example, a force sensor may be disposed on the base part of the robot, and the robot can be operated in the same manner as in the case of direct teaching. The operator can change the position and the orientation of the robot by directly pushing or pulling the constituent members of the robot.

Referring to FIG. 2, the display control unit 54 in the present embodiment can display an image so that the direction of the force pressing the first workpiece 71 can be seen when the operation of bringing the end surface 71b of the first workpiece 71 into contact with the corner portion 72b of the second workpiece 72 is performed.

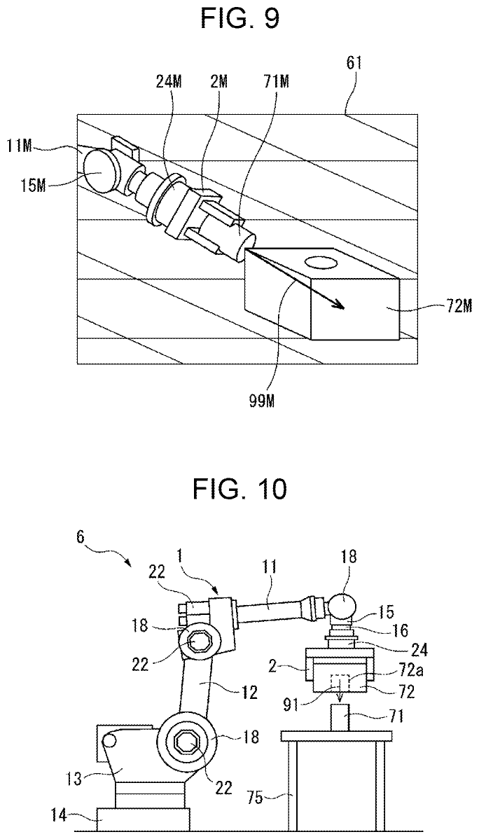

FIG. 9 illustrates the image displayed on the display part. In an image 61, part of the first workpiece that comes into contact with the second workpiece is enlarged. Referring to FIGS. 2 and 9, in the present embodiment, three-dimensional shape data 58 of the robot apparatus 5, the first workpiece 71, and the second workpiece 72 is stored in the storage 42. The display control unit 54 generates a model of each member based on the three-dimensional shape data 58.

The actual positions of the robot apparatus and the workpiece are input in advance. The display control unit 54 arranges a model in a virtual space according to the actual positions of the robot apparatus and the workpiece. The display control unit 54 generates an image of the model of the workpiece as viewed along a predetermined direction. The display control unit 54 acquires the position and the orientation of the robot 1 based on the output from the position detector 19. The display control unit 54 generates an image of the model of the robot apparatus based on the position and the orientation of the robot 1.

In the image 61, a model 71M of the first workpiece and a model 72M of the second workpiece are displayed. Among the models of the robot apparatus, a model 2M of the hand, a model 24M of the force sensor, a model 15M of the wrist part, and a model 11M of the upper arm are displayed.

The display control unit 54 acquires the pressing direction of the workpiece 71 from the movement direction calculating unit 52. The display control unit 54 displays an arrow indicating the pressing direction on the image. In this case, the display control unit 54 displays an arrow 99M in the pressing direction of the workpiece 71 so as to extend from a corner portion of the model 72M of the second workpiece.

As described above, during a period in which the robot is driven so as to press one of the first workpiece 71 and the second workpiece 72 toward the other one of the workpieces, the display control unit 54 acquires the pressing direction of the workpiece calculated by the movement direction calculating unit 52 and displays the pressing direction superimposed on the image of the robot 1. It should be noted that the position calculating unit 53 can calculate the position of the contact point by performing the control of pressing the workpiece in the second and subsequent controls. Thus, the display control unit 54 may acquire the position of the contact point from the position calculating unit 53 and display the contact point so as to be superimposed on the image of the robot 1.

The operator can check the pressing direction of the first workpiece 71 with respect to the second workpiece 72, on the image 61 displayed on the display part 39. The operator can determine whether the pressing direction of the workpiece is appropriate. For example, when the pressing direction of the first workpiece is set to the movement direction of the first workpiece, the operator can determine whether the pressing direction is appropriate. The operator can change the position and the orientation of the robot 1 while viewing the image 61.

The operator may have difficulty in visually checking the actual contact portion of the workpiece. Further, when the workpiece is small, it may be difficult to check the orientation of the workpiece to be pressed. Even in such a case, the operator can adjust the direction in which one workpiece is pressing another workpiece while viewing the image displayed on the display part.

It should be noted that the display control unit 54 can display any information related to the pressing direction of the workpiece and the position of the contact point on the display part. For example, the movement direction or the position of the contact point may be displayed by using coordinate values of a predetermined coordinate system. For example, the pressing direction of the workpiece may be displayed by using coordinate values of the W-axis, the P-axis, and the R-axis in the reference coordinate system.

FIG. 10 is a schematic view of a second robot apparatus according to the present embodiment. In a second robot apparatus 6, the first workpiece 71 is fixed to the work stand 75. The second workpiece 72 is gripped by the hand 2 and moved by the second robot apparatus 6. The second robot apparatus 6 moves the workpiece 72 as indicated by the arrow 91 and then performs work of fitting the workpiece 71 into the recess 72a of the workpiece 72.

Also in the second robot apparatus 6, as in the first robot apparatus 5, the force control is performed for controlling the position and the orientation of the robot 1 so as to reduce the force in a predetermined direction applied to the distal end of the first workpiece 71. In particular, the position and the orientation of the robot 1 are controlled so that the force applied to the tip of the workpiece 71 in a direction other than the direction parallel to the movement direction and the moment applied to the tip of the workpiece 71 approach zero. In the parameter setting procedure, for performing the force control, the workpiece tip point is set on the end surface 71b of the first workpiece 71. Further, the movement direction in which the second workpiece 72 is moved with respect to the first workpiece 71 is set.

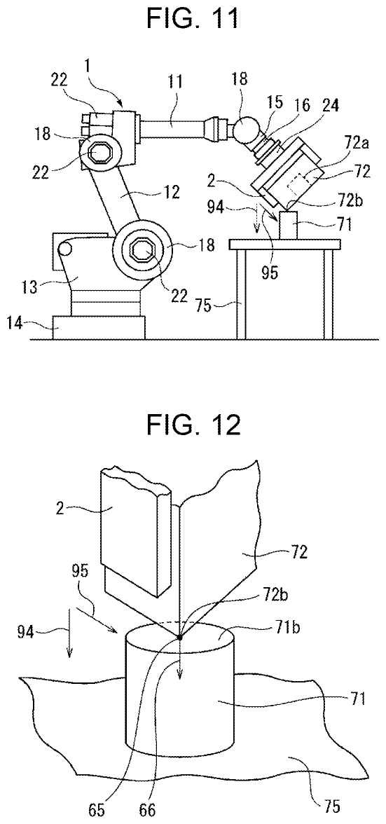

FIG. 11 is a schematic view of the second robot apparatus when the corner portion of the second workpiece is brought into contact with the first workpiece. FIG. 12 is an enlarged perspective view of a portion where the second workpiece comes into contact with the first workpiece. Referring to FIGS. 11 and 12, the operator manually drives the robot apparatus and performs a control of pressing the second workpiece 72 serving as the contact member to first workpiece 71. The operator brings the corner portion 72b of the second workpiece 72 into contact with the end surface 71b of the workpiece 71. At this time, the operator brings the corner portion 72b into contact with the workpiece tip point in the actual fitting work.

When the second workpiece 72 is pressed to the first workpiece 71 in a plurality of the pressing directions, the parameter calculating unit 51 acquires the force that is detected by the force sensor 24 and corresponds to each pressing direction. The parameter calculating unit 51 calculates the movement direction of the second workpiece 72 and the position of the workpiece tip point of the first workpiece 71 based on the force corresponding to the plurality of pressing directions.

In the first control of pressing the second workpiece 72, the robot 1 is driven so as to press the second workpiece 72 in a predetermined pressing direction indicated by an arrow 94. In such a situation, the robot 1 is driven so as to press the second workpiece 72 to the first workpiece 71 along the direction of movement (movement direction) in the actual fitting work. The position and the orientation of the robot 1 are changed so as to press the second workpiece 72 in a direction parallel to the direction in which the center axis of the first workpiece 71 extends. The force sensor 24 detects force applied to the second workpiece 72 during a period in which the second workpiece 72 is pressed to the first workpiece 71.

In the second control of pressing the second workpiece 72, the robot 1 is driven so as to press the second workpiece 72 in a predetermined pressing direction indicated by an arrow 95. As the pressing direction in the second control, a direction different from the pressing direction in the first control is employed. The force sensor 24 detects force applied to the second workpiece 72 during a period in which the second workpiece 72 is pressed to the first workpiece 71.

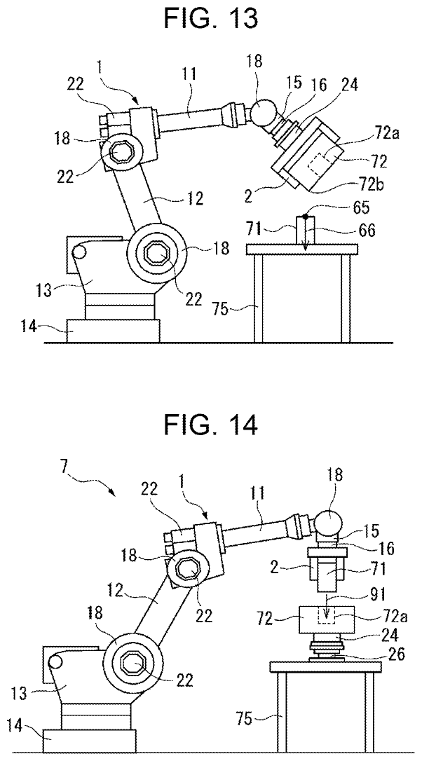

FIG. 13 is a schematic view of the robot apparatus illustrating parameters set by pressing the corner portion of the second workpiece to the end surface of the first workpiece. Referring to FIGS. 2, 12, and 13, the movement direction calculating unit 52 of the parameter calculating unit 51 can calculate the pressing directions based on the force in the directions of the orthogonal axes in the sensor coordinate system. The movement direction calculating unit 52 sets one of the pressing directions calculated based on the output of the force sensor 24 to the movement direction indicated by the arrow 66.

The position calculating unit 53 of the parameter calculating unit 51 calculates the line of action based on the pressing directions and the moments around the orthogonal axes in the sensor coordinate system. The position calculating unit 53 calculates a plurality of lines of action corresponding to the plurality of pressing directions based on the output of the force sensor 24. The position calculating unit 53 can calculate the position of the workpiece tip point 65 of the workpiece 71 based on the plurality of lines of action.

The parameter calculating unit 51 calculates the movement direction and the position of the workpiece tip point in the sensor coordinate system 82 when the second workpiece 72 is in contact with the first workpiece 71. Next, based on the position and the orientation of the robot when the second workpiece 72 is in contact with the first workpiece 71, the parameter calculating unit 51 converts the movement direction and the position of the workpiece tip point 65 expressed in the sensor coordinate system 82, into the movement direction and the position of the workpiece tip point 65 expressed in the reference coordinate system 81.

In the second robot apparatus 6, the parameter calculating unit 51 sets, in the operation program 46, the movement direction and the position of the workpiece tip point 65 in the reference coordinate system 81. Alternatively, the operator can set, in the operation program 46, the movement direction and the position of the workpiece tip point 65 displayed on the display part 39. As described above, when the second workpiece 72 is fitted to the first workpiece 71 fixed to the work stand, the workpiece tip point 65 and the movement direction can be set with respect to the first workpiece 71 fixed to the work stand.

Next, the operator sets the initial position and initial orientation of the second workpiece 72 when the control of fitting the workpiece 72 to the workpiece 71 is performed. The operator manually operates the robot 1 so as to arrange the recess 72a of the workpiece 72 directly above the workpiece 71 as illustrated in FIG. 10. The operator adjusts the position and orientation of the robot so that the center axis 71a of the workpiece 71 substantially overlap the center axis 72aa of the recess 72a. The parameter calculating unit 51 or the operator sets the position and the orientation of the robot at this time in the operation program 46 as the initial position and the initial orientation of the robot at which the control of fitting the workpiece is started.

In the control of actually fitting the second workpiece 72 to the first workpiece 71, force control similar to that in the first robot apparatus can be performed. The operation control unit 43 starts the force control after driving the robot 1 to its initial position and orientation. The operation control unit 43 drives the robot 1 so as to move the second workpiece 91 in the movement direction. The force detected by the force sensor 24 (force in the X-axis, Y-axis, and Z-axis directions and moments in the W-axis, P-axis, and R-axis directions) are converted into force acting on the workpiece tip point 65 based on the position and orientation of the robot. The operation control unit 43 controls the position and the orientation of the robot so that the force applied to the workpiece tip point 65 in the predetermined direction falls within the predetermined determination range. In this way, the controller 4 can perform force control based on the workpiece tip point 65 and the movement direction indicated by the arrow 66.

Also in the second robot apparatus, the display control unit 54 of the parameter calculating unit 51 can display, on the display part 39, an image when the robot 1 is driven so as to press the second workpiece 72 to the first workpiece 71. The display control unit 54 acquires the movement direction calculated by the movement direction calculating unit 52 and displays the movement direction superimposed on the image of the robot 1. The display control unit 54 may display the workpiece tip point 65 calculated by the position calculating unit 53 on the image.

In the above-described embodiment, the second workpiece is used as a contact member with which the first workpiece is brought into contact, but the embodiment is not limited to this. As the contact member, any member including a corner portion having a tip can be employed. For example, a jig including a corner portion may be moved by the robot apparatus.

Other configurations, actions, and effects of the second robot apparatus are similar to those of the first robot device, and the description thereof will not be repeated here.

FIG. 14 is a schematic view of a third robot apparatus according to the present embodiment. In a third robot apparatus 7, the position where the force sensor 24 is arranged is different from that in the first robot apparatus 5. The force sensor 24 is arranged between the second workpiece 72 supported by the work stand 75 and the surface of the work stand 75. The force sensor 24 is fixed to the work stand 75 via a supporting member 26. The second workpiece 72 is fixed to the work stand 75 via the force sensor 24 and the supporting member 26. Also in the third robot apparatus 7, control that is similar to that in the parameter setting procedure of the first robot apparatus 5 can be performed.

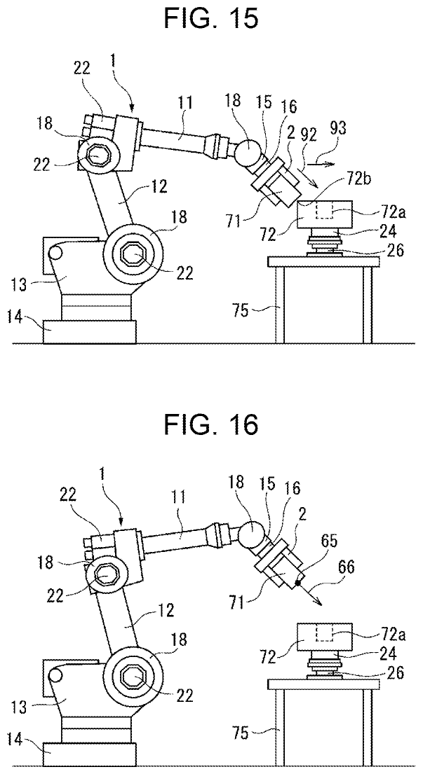

FIG. 15 is a schematic view of the third robot apparatus when the first workpiece is pressed to the second workpiece. As in the first robot apparatus 5, the operator brings the workpiece tip point of the first workpiece 71 into contact with the corner portion 72b of the second workpiece 72. In the first control of pressing the first workpiece 71, the first workpiece 71 is pressed toward the second workpiece 72 as indicated by the arrow 92. In such a situation, the first workpiece 71 is pressed to the second workpiece in a direction parallel to the movement direction in which the first workpiece 71 is moved in the actual fitting work. The force sensor 24 detects force applied to the second workpiece 72.

In the second control performed of pressing the first workpiece 71, the first workpiece 71 is pressed toward the second workpiece 72 as indicated by the arrow 93. The pressing direction indicated by the arrow 93 is different from the pressing direction indicated by the arrow 92. The force sensor 24 detects force applied to the second workpiece 72.

The movement direction calculating unit 52 calculates the pressing direction acting on the second workpiece 72 based on the force (the force in the X-axis, Y-axis, and Z-axis directions) detected by the force sensor 24. The pressing direction acting on the second workpiece 72 corresponds to the direction in which the first workpiece 71 is pressed to the second workpiece 72. The movement direction calculating unit 52 sets the pressing direction indicated by the arrow 92 as the movement direction.

The position calculating unit 53 calculates the position of the workpiece tip point based on the pressing direction and the force (moments in the directions of the W-axis, the P-axis, and the R-axis) detected by the force sensor 24. The position calculating unit 53 calculates a plurality of lines of action based on a plurality of pressing directions, and calculates the position of the workpiece tip point based on the plurality of lines of action. The parameter calculating unit 51 calculates the movement direction and the position of the contact point in the sensor coordinate system 82. The parameter calculating unit 51 acquires the position and the orientation of the robot 1 when the workpiece tip point of the first workpiece 71 is in contact with the corner portion of the second workpiece.

Based on the position and the orientation of the robot 1, the parameter calculating unit 51 converts the movement direction and the position of the workpiece tip point expressed in the sensor coordinate system 82 into the movement direction and the position of the workpiece tip point expressed in the flange coordinate system 83. The parameter calculating unit 51 or the operator can set the movement direction and the position of the tool center point expressed in the flange coordinate system 83 in the operation program 46 as parameters of force control.

FIG. 16 is a perspective view of the third robot apparatus illustrating the workpiece tip point and the movement direction of the workpiece calculated by the parameter calculating unit. The workpiece tip point 65 and the movement direction indicated by the arrow 66 are set for the first workpiece 71 gripped by the hand 2, as in the case of the first robot apparatus 5. The workpiece tip point 65 and the movement direction move together with the first workpiece 71.

When the work of fitting the first workpiece 71 into the recess 72a is performed, the operation control unit 43 can convert the force detected by the force sensor 24 into the force acting on the workpiece tip point 65 based on the position and the orientation of the robot 1. Also in the third robot apparatus 7, force control similar to that in the first robot apparatus 5 can be performed. In other words, when the work of fitting the first workpiece 71 into the recess 72a is performed, the force control can be performed based on the workpiece tip point 65 and the movement direction indicated by the arrow 66.

Also in the third robot apparatus, any jig having a corner portion may be fixed to the work stand as the contact member instead of the second workpiece. Also in this case, the control of pressing the first workpiece to the corner portion of the jig can be performed.

In the third robot apparatus 7, the contact member is fixed to the work stand and the first workpiece is moved by the robot, but the embodiment is not limited to this. As in the case of the second robot apparatus 6, the first workpiece may be fixed to the work stand and the contact member may be moved by the robot. For example, the first workpiece may be fixed to the work stand via the force sensor and the second workpiece may be gripped and moved by the robot apparatus. In this case, the force sensor 24 detects the force applied to the first workpiece. As in the case of the second robot apparatus 6, the workpiece tip point and the movement direction may be set for the first workpiece fixed to the work stand (see FIG. 12). In the parameter setting procedure, the movement direction and the position of the workpiece tip point can be set based on the output of the force sensor fixed to the work stand.

Other configurations, actions, and effects of the third robot apparatus are similar to those of the first robot apparatus and the second robot apparatus, and the description thereof will not be repeated here.

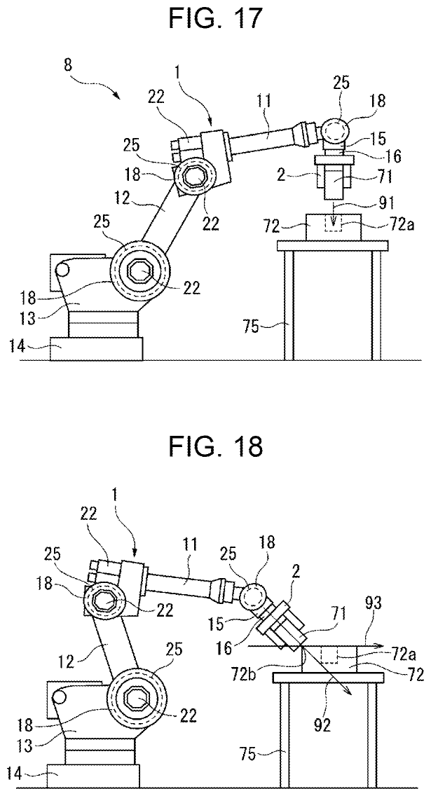

FIG. 17 is a schematic view of a fourth robot apparatus according to the present embodiment. In a fourth robot apparatus 8, a torque sensor 25 serving as a force detector is arranged instead of the force sensor 24 fixed to the robot 1 or the work stand 75. A plurality of the torque sensors 25 are disposed on the drive axes of the plurality of joints 18 of the robot 1. In the present embodiment, torque sensors 25 are disposed on all of the six drive axes. Each torque sensor 25 detects a torque around the drive axis of the joint 18.

Referring to FIG. 2, in the fourth robot apparatus 8, the torque sensor 25 is arranged instead of the force sensor 24 of the first robot apparatus 5. The output from the torque sensor 25 is transmitted to the parameter calculating unit 51. The parameter calculating unit 51 calculates the position of the workpiece tip point in the first workpiece 71 and the movement direction of the first workpiece 71 based on the force (torque around the drive axis) output from each torque sensor 25.

FIG. 18 is a schematic view of the robot apparatus when the first workpiece is brought into contact with the corner portion of the second workpiece. As in the case of the first robot apparatus 5, the operator brings the workpiece tip point of the first workpiece 71 into contact with the corner portion of the second workpiece 72. In the first control of pressing the first workpiece 71, the robot 1 is driven so as to press the first workpiece 71 toward the second workpiece 72 as indicated by the arrow 92. The pressing direction indicated by the arrow 92 corresponds to the movement direction of the first workpiece 71 in the actual fitting work.

The torque sensor 25 detects a torque around each drive axis. The movement direction calculating unit 52 can calculate the pressing direction of the first workpiece 71 indicated by the arrow 92, based on the output from the plurality of torque sensors 25. The movement direction calculating unit 52 can calculate the pressing direction by using force balance or the principle of virtual work. The arrow 92 corresponds to the line of action on which the contact point as the workpiece tip point is present. The movement direction calculating unit 52 can set the pressing direction of the first workpiece 71 indicated by the arrow 92 as the movement direction.

In the fourth robot apparatus 8, the pressing direction can be acquired in the control of pressing the workpiece in one direction, but the position of the workpiece tip point (the position of the contact point at which the workpieces come into contact with each other) cannot be calculated. The fourth robot apparatus 8 calculates, in order to specify the position of the contact point located on a straight line in the pressing direction, the position of the workpiece tip point by pressing the workpiece 71 toward the workpiece 72 from another direction.

In this case, the control of pressing the first workpiece 71 from a direction different from the first pressing direction is performed while maintaining the position and the orientation of the robot 1. In the second control of pressing the first workpiece 71, the robot 1 is driven so as to press the first workpiece 71 to the corner portion 72b of the second workpiece 72 in the direction indicated by the arrow 93. The movement direction calculating unit 52 calculates the pressing direction of the first workpiece 71 indicated by the arrow 93 based on the output from the plurality of torque sensors 25. The arrow 93 corresponds to the line of action on which the contact point is present.

The position calculating unit 53 calculates the intersection point between two pressing directions in which the workpiece 71 is pressed as the contact point at which the first workpiece 71 is in contact with the second workpiece 72. In other words, the position calculating unit 53 calculates the position of the intersection point between the arrow 92 and the arrow 93 as the position of the workpiece tip point 65. By performing the control of pressing the first workpiece to the corner portion from two or more directions as described above, the intersection point between the vectors of the pressing directions can be calculated as the position of the workpiece tip point.

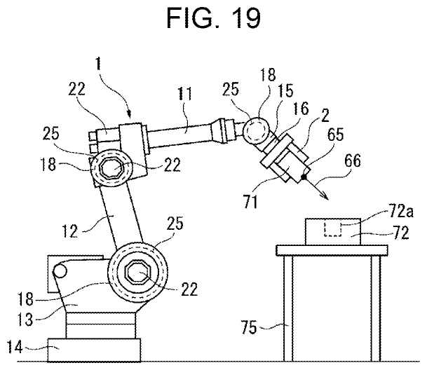

FIG. 19 is a schematic view of the fourth robot apparatus illustrating parameters generated for force control. The parameter calculating unit 51 of the fourth robot apparatus 8 calculates the position of the workpiece tip point 65 and the movement direction indicated by the arrow 66 in the flange coordinate system. In the control of fitting the workpiece, the operation control unit 43 calculates the force acting on the workpiece tip point 65 based on the outputs from the plurality of torque sensors 25. The operation control unit 43 can perform force control based on the position and the movement direction of the workpiece tip point 65.

In the fourth robot apparatus 8, the robot 1 supports the first workpiece 71 and inserts the first workpiece 71 into the recess 72a of the second workpiece 72, but the embodiment is not limited to this. As in the second robot apparatus 6, the first workpiece 71 may be fixed to the work stand 75 and the fourth robot apparatus 8 may move the second workpiece 72. In this case, the workpiece tip point and the movement direction are set for the first workpiece. The operator moves the contact member such as the second workpiece 72 by using the robot and brings the corner portion of the contact member into contact with the workpiece tip point of the first workpiece 71 in order to calculate the movement direction and the position of the workpiece tip point. The parameter calculating unit 51 can calculate the movement direction and the position of the workpiece tip point based on the output from the torque sensor 25.

Other configurations, operations, and effects of the fourth robot apparatus are similar to those from the first robot apparatus to the third robot apparatus, and the description thereof will not be repeated here.

In the above-described embodiment, the position of the workpiece tip point is calculated with measurement performed while changing the direction in which one workpiece is pressed to another workpiece without changing the orientation of the one workpiece, but the embodiment is not limited to this. In the pressing control in the second and subsequent controls, the relative direction in which one workpiece is pressed to another workpiece may be changed. For example, when the first workpiece is pressed to the second workpiece, the orientation of the first workpiece with respect to the second workpiece can be changed in the second control of pressing the first workpiece. Then, the control of pressing the first workpiece to the second workpiece in the same direction as the pressing direction in the first control in the reference coordinate system can be performed. Also in this case, the position of the workpiece tip point can be calculated based on the line of action corresponding to the pressing direction.

In the above-described embodiment, the control of fitting the cylindrical workpiece is described, but the control of the present embodiment can be applied to a workpiece having any shape. In the present embodiment, the control of fitting one workpiece to another workpiece has been described, but the embodiment is not limited to this. The controller according to the present embodiment can be applied to any work of moving one workpiece toward another workpiece, such as surface alignment between workpieces or hole searching. In particular, the control according to the present embodiment can be applied to work in which force control is performed since a workpiece is brought into contact with another object when the workpiece is moved by a robot. The fitting work is not limited to the work of inserting the workpiece into a recess or a hole, and includes, for example, work of arranging a gear at a predetermined position while matching the phases of teeth of the gear.

The above-described embodiments can be combined as appropriate. In each of the above drawings, the same or similar parts are denoted by the same reference numerals. It should be noted that the above-described embodiment is an example and does not limit the invention. The embodiment includes modifications of the embodiment described in the claims.

### REFERENCE SIGNS LIST

1 robot
2 hand
4 controller
9 gripping member
wrist part
16 flange
18 joint
24 force sensor
25 torque sensor
37 teach pendant
39 display part
40 controller body
43 operation control unit
51 parameter calculating unit
52 movement direction calculating unit
53 position calculating unit
54 display control unit
61 image
65 workpiece tip point
66 arrow
71, 72 workpiece
71b end surface
72b corner portion
75 work stand
81 reference coordinate system
82 sensor coordinate system
83 flange coordinate system
85, 86 line of action
99M arrow

1. A controller configured to calculate a parameter for performing force control when a robot moves a first workpiece toward a second workpiece, comprising:
a force detector configured to detect force applied to one of the first workpiece and a contact member when the robot brings the first workpiece into contact with the contact member including a corner portion; and
a parameter calculating unit configured to calculate a movement direction in which the first workpiece moves with respect to the second workpiece when the force control is performed and a position of a workpiece tip point serving as a control point in the force control, wherein
the force detector detects force during a period in which the robot brings the workpiece tip point of the first workpiece into contact with the corner portion of the contact member and presses the first workpiece along a predetermined pressing direction, and
the parameter calculating unit acquires the force that is detected by the force detector and corresponds to each of a plurality of pressing directions when the first workpiece is pressed to the contact member in the plurality of pressing directions, and calculates the movement direction of the first workpiece and the position of the workpiece tip point of the first workpiece based on the force corresponding to the plurality of pressing directions.

2. A controller configured to calculate a parameter for performing force control when a robot moves a second workpiece toward a first workpiece, comprising:
a force detector configured to detect force applied to one of the first workpiece and a contact member when the robot brings the contact member including a corner portion into contact with the first workpiece; and
a parameter calculating unit configured to calculate a movement direction in which the second workpiece moves with respect to the first workpiece when the force control is performed and a position of a workpiece tip point serving as a control point in the force control, wherein
the force detector detects force during a period in which the robot brings the corner portion of the contact member into contact with the workpiece tip point of the first workpiece and presses the contact member along a predetermined pressing direction, and
the parameter calculating unit acquires the force that is detected by the force detector and corresponds to each of a plurality of pressing directions when the contact member is pressed to the first workpiece in the plurality of pressing directions, and calculates the movement direction of the second workpiece and the position of the workpiece tip point of the first workpiece based on the force corresponding to the plurality of pressing directions.

3. The controller of claim 1, wherein the force detector includes a six-axis force sensor attached to the robot or a work stand supporting the workpiece.

4. The controller of claim 1, wherein
the robot includes a wrist part including a flange, and
the force detector is arranged between the flange and an operation tool.

5. The controller of claim 1, wherein the force detector is arranged between a workpiece supported by the work stand and a surface of the work stand.

6. The controller of claim 1, wherein
the robot is an articulated robot including a plurality of drive axes, and
the force detector includes a torque sensor arranged at each of the plurality of drive axes.

7. The controller of claim 1 further comprising:
a display part configured to display an image of the robot; and
a display control unit configured to control the image displayed on the display part, wherein
the display control unit acquires the pressing direction calculated by the parameter calculating unit during a period in which the robot is driven so as to press one of the first workpiece and the contact member toward another one of the first workpiece and the contact member, and displays the pressing direction superimposed on the image of the robot.

8. The controller of claim 1, wherein the parameter calculating unit calculates a line of action on which the workpiece tip point is present, based on force that is detected by a detector and corresponds to each of the plurality of pressing directions, and calculates an intersection point between a plurality of the lines of action as the workpiece tip point.

9. The controller of claim 1, wherein the parameter calculating unit calculates a line of action on which the workpiece tip point is present, based on force that is detected by a detector and corresponds to each of the plurality of pressing directions, and calculates the position of the workpiece tip point based on distance from a plurality of the lines of action, when at least one of the plurality of lines of action does not intersect another line of action of the plurality of lines of action.

10. The controller of claim 1, further comprising an operation control unit configured to control a motion of the robot, wherein
the operation control unit performs a control of fitting a workpiece supported by the robot to a workpiece fixed to a work stand, based on the position of the workpiece tip point and the movement direction calculated by the parameter calculating unit.
